(19) United States
(12) Patent Application Publication
(10) Pub. No.: US 2006/0104761 A1
(43) Pub. Date: May 18, 2006

(54) Bottle emptying apparatus with bottle holders accomodating different bottle sizes and shapes

(75) Inventor: Mario Lanfranchi, COLLECCHIO (IT)

Correspondence Address: Philip K Fitzsimmons;Shlesinger Fitzsimmons & Shlesinger, 183 East Main Street, 1323 Alliance Building, Rochester, NY, 14604, US

(73) Assignee: LANFRANCHI S.R.L., PARMA (IT)

(21) Appl. No.: 10/535,662

(22) PCT Filed: Nov. 6, 2003
(86) PCT No.: PCT/EP03/12389

§ 371 Date: May 19, 2005

(30) Foreign Application Priority Data
Nov. 20, 2002 (IT) PR2002A000069

(51) Int. Cl. B65G 9/00

(52) U.S. Cl. 414/405

(57) ABSTRACT

The invention refers to the field of machines for orienting and aligning bottles or vessels generally made of plastics and in particular refers to a device for automatically adjusting means for emptying the plastics vessels in an orienting and aligning machine in which means are provided for adjusting the emptying devices adapted to free the machine from three major vessel dimensions. The emptying means are composed of a plurality of tanks or cradles (2) and an underlying and corresponding plurality of discharge channels (3) connected to a cylinder wall (4) rotating around a vertical or slanted axis.

The present invention relates to a device for automatically adjusting means for emptying plastic vessels in an orienting and aligning machine.

Device or systems for automatically adjusting orienting and aligning machines depending on the vessel format, and more precisely for adjusting the emptying device composed of a set of discharge cradles and of underlying channels that carry the vessels in a vertical and aligned arrangement, are already known.

All the known machines allow an adjustment depending on similar vessels.

Briefly stated, the format change is performed only and exclusively within bottles that, though changing their capacity, keep similar ratios among the three major dimensions.

The main object of the present invention is adjusting the emptying means with anyway variable vessels without taking into account determined dimensional ratios but depending on three major quantities that can be defined as:
H) vessel height;
A) longitudinal dimension of the vessel base;
B) transverse dimension of the vessel base.
A) and B) could in some cases coincide for vessels with square section or for vessels with circular section, in which case A) and B) would coincide with the vessel diameter.

These three dimensions have influence on the emptying device geometry, where the term emptying device means cradle and discharge channel.

More precisely, in the cradle part, the relevant geometries are H) and B), where

An example of the prior art is discloses in EP 1 016 601 and regard an adjustable unit for unscrambling empty containers, using compartments with open bottom delimited by arrangements for supporting the open end of the vessel.

An other machine is discloses in EP 0 578 602 and regard an adjustable unit for unscrambling empty vessel, wherein the cavities are formed by a series of individual compartments similarly to the discharge chutes, both the compartments and the chutes being apt to be fixed in a plug-in connection to the periphery of rotary structure.

The same applicant discloses an unscramble machine in WO 03/024847.

B) is less than or equal to A).

Underlying the cradle, a discharge channel is provided that can be substantially divided into two areas, a funnel-shaped upper part and a vertical channel-shaped end part.

The funnel-shaped upper part is governed by three geometries: in the upper (top) inlet part dimension H) is determined.

Afterwards, when the vessel has been straightened, namely vertically placed, the dimension determining the funnel is A) along a direction and B) along the other direction to avoid rotating the vessel around its own vertical axis.

A further object of the present invention is allowing, also a posteriori, to handle the vessels without knowing a priori the vessel dimensions or the ratios among vessels, and therefore being able to be completely freed from the above-mentioned three major dimensions H), A) and B).

A further object is being able to operate on the emptying means depending on the three above-mentioned dimensions one independently from the other.

A further object of the invention is intervening on every single adjustment at different times.

These objects are all obtained by the device for automatically adjusting the emptying means of plastics vessels in an orienting and aligning machine, object of the present invention, that is characterised in what is provided in the below-enclosed claims.

These and other features will be better pointed out by the following description of a preferred embodiment, shown merely as a non-limiting example, in the enclosed drawing tables in which:

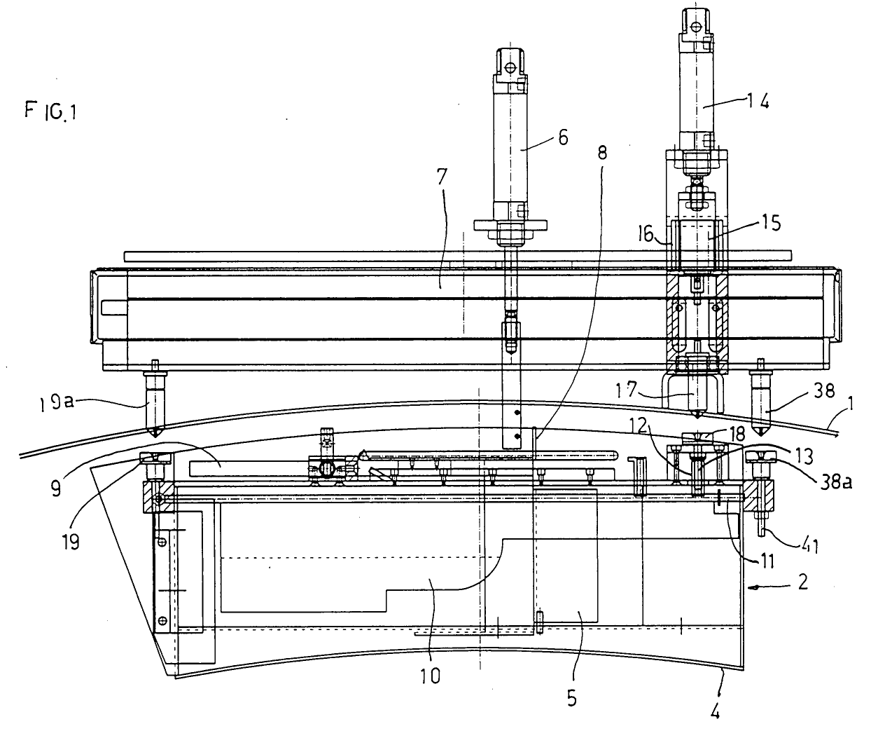

FIG. 1 shows in a plan view the part of the emptying device cradle;

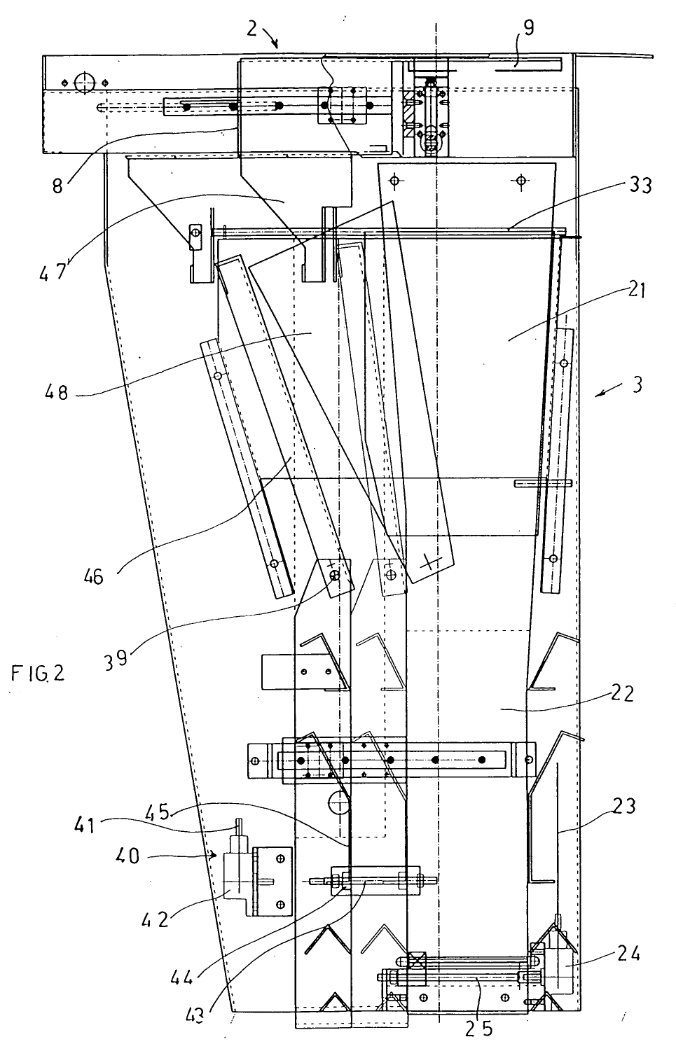

FIG. 2 shows an elevation of the emptying device in a front view;

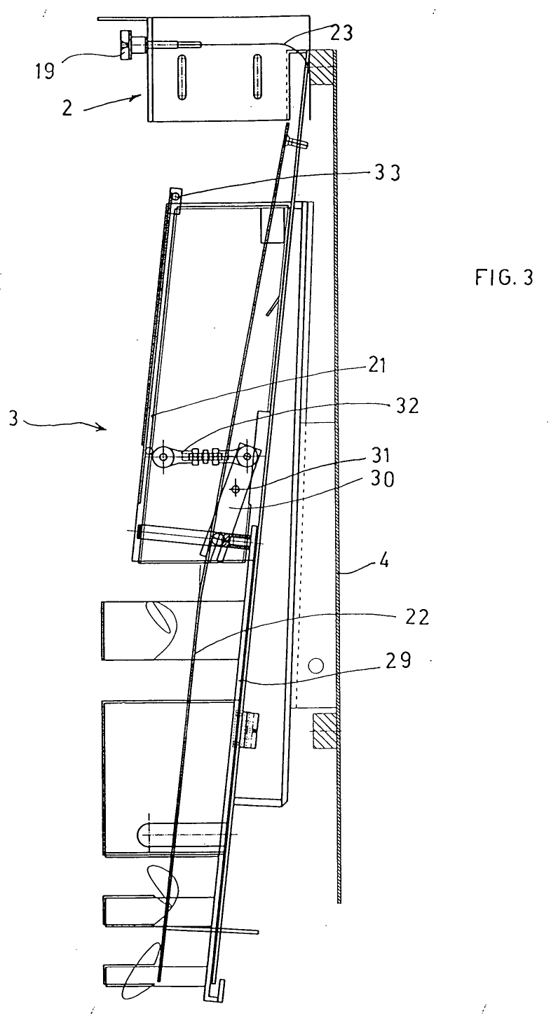

FIG. 3 shows the emptying device in a side view;

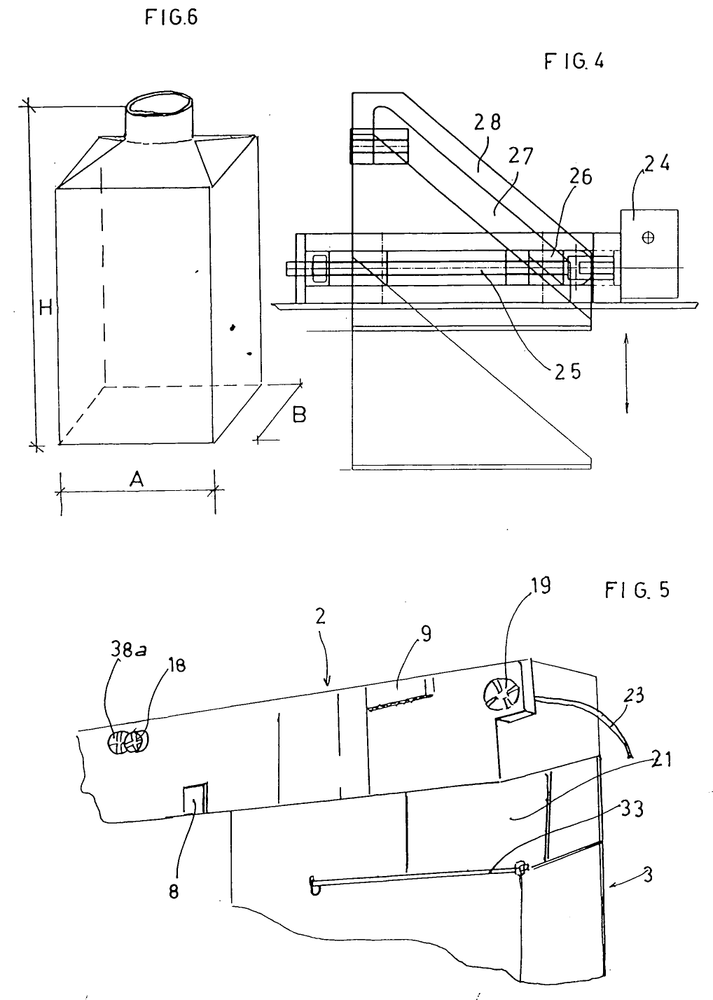

FIG. 4 shows in a plan view a part of FIG. 2;

FIG. 5 shows in a schematic perspective view an emptying device in which adjustment drives are pointed out;

FIG. 6 shows a vessel in which the three major dimensions are pointed out.

With reference to FIGS. 1 and 2, 1 designates a fixed cylinder wall of a straightening and aligning machine for vessels or bottles.

Inside this cylinder wall, as known, emptying means are placed, that are substantially composed of a plurality of cradles or tanks 2 and of a corresponding plurality of discharge hoppers or channels 3 placed below the tanks.

The emptying devices are supported by an internal cylinder wall 4 rotating around a vertical axis.

The tank or cradle provides for a slider 5 whose position can be adjusted inside the cradle itself depending on the vessel height.

The adjustment is obtained by motoring the slider itself through a pneumatic cylinder 6 carried by a slider 7 moving horizontally and perpendicularly to the pneumatic cylinder axis.

The pneumatic cylinder stem is made interact with a bracket 8 integral with the slider 5 once a positioning locking system has been deactivated.

For such purpose a rack 9 is provided that operates as locking once having reached the desired position that defines dimension H).

Inside the tank a blade 10 is also provided, and is longitudinally arranged along the external tank wall to define the tank width depending on vessel dimension B). Having placed the blade along the external tank wall, its inside can be used as fixed wire that is placed next to the rotating cylinder wall 4.

For such purpose the blade is supported by an idle shaft 11 that can rotate through the thrust of a small block 12 screwed onto a worm screw 13 actuated by a stepped motor 15 assembled on a slider 16 that can radially translate with respect to the machine under the thrust of a jack 14.

On the shaft a male coupling 17 is keyed-in and can be inserted in a corresponding female coupling 18 keyed-in on the worm screw 13; its insertion and then its coupling operations are realised by actuating the jack 14.

The transverse cradle dimension can therefore be adjusted by rotating the blade 10 towards the cradle interior with irreversible movements that therefore need stop members once having reached the desired position.

With reference to FIGS. 2 and 3, the discharge hopper, globally designated as 3, provides two false backs, an upper one 21 and a lower one 22.

The position of said backs 21 and 22, with respect to the vertical, can simultaneously change by actuating a stepped motor (not shown) that intervenes on a male female coupling 19 and 19a rather similar to the previously described one, to which coupling a small cable 23 is connected, that goes down to the lower channel part where a 90° transmission 24 is provided that moves a worm screw 25 that drags and moves a small triangular block 26 inserted inside a slot 27 that is slanted with respect to the worm screw axis and is obtained in a bracket 28 that is integral with the lower back 22 (see FIG. 4).

The worm screw 25 rotation generates the block 26 translation that in turn generates the false back 22 displacement that approaches or goes away from the other fixed wall 29 that defines the discharge channel.

The lower false back 22 is upward connected to a lever 30 hinged in 31 to the fixed wall; the other end of the lever is connected to a connecting rod 32 that is connected to the upper false wall 21.

The false back 21 is upward supported by an idle pin 33 around which the upper false back can rotate when the connecting rod 32 and lever 30 system is actuated by the translation of the lower false back.

40 designates another adjustment system comprising a small cable 41 that can be actuated with a stepped motor system (not shown) that actuates a male female coupling 38 and 38a quite similar to the previous one related to the lower false back displacement.

The small cable descends down to the lower part of the discharge channel where an angular transmission 42 is placed that is directly engaged to a worn screw 43 on which a small block 44, integral with a moving vertical wall 45 of the discharge channel, can slide.

The vertical wall 45 can therefore translate in order to widen or shorten the tangential dimension depending on dimension A).

A slanted wall 46 is upper hinged in 39 to the vertical wall 45, such wall 46 conferring to the discharge channel a substantially funnel shape; the slanted wall 46 has a variable slant depending on the vertical wall 45 and the cradle slider 5 position.

The cradle slider 5 in fact provides for a vertical wall 47 that descends till it interacts with the slanted wall 46 of the discharge channel 3.

The slanted wall 46 in its translating and rotating movements accompanies, in a rotating movement, a plate 48 whose function is closing the space that is created in the bottom wall when the displacement of said slanted wall occurs.

From the description it is evident that the device structured with four independent drives to change the dimensions of cradle and discharge channel depending on the three major dimensions A, B and H of a vessel, allows a posteriori to handle the vessels without knowing their major dimensions a priori; briefly, the machine that assembles a plurality of said devices is completely freed from the three above-mentioned major dimensions, obviously within maximum limits above which the machine cannot work.

It is evident that the machine, and namely the internal cylinder wall 4, must be unmoving when the motoring engagement systems that perform the movements are actuated.

The four movements that perform the above-described adjustments can be carried out, in addition to electric or pneumatic actuators as shown, also totally or partly manually.

1. A device for automatically adjusting evacuation's means in an orienting and aligning machine in which the evacuation's means are integral with a cylinder wall rotating around a vertical or slanted axis and comprise a plurality of cradles or tanks under which a corresponding plurality of discharge hoppers or channels are placed, characterized in that it provides adjusting means for cradles and vertical channel adapted to allow handling the vessels without knowing a priori the vessel dimensions and the ratios among vessels with different capacity in order to the able to be completely freed from the three major dimensions, said means operating on moving portions of the emptying means one independently from the other.

2. A device according to claim 1, characterized in that it provides for a slider whose position can be adjusted inside the cradle depending on the vessel height, said slider being able to be moved through a pneumatic cylinder equipped with a radial movement for approaching to and going away from a bracket integral with the slider and an horizontal translation movement perpendicular to the radial movement.

3. A device according to claim 2, characterized in that it provides for a rack locking to ensure the position reached by the slider.

4. A device according to claim 1, characterized in that it provides for a blade arranged longitudinally along the external tank wall to define the tank width depending on the transverse vessel dimension, the blade being equipped with means for forcing it to rotate around an idle shaft supported by the tank itself.

5. A device according to claim 1, characterized in that it comprises two false backs, an upper one and a lower one, each one of which can change its slant with respect to the vertical direction to define the discharge channel depth.

6. A device according to claim 5, characterized in that it comprises a small cable that descends down to the lower channel part and that actuates a worm screw that drags and moves a small triangular block inserted inside a slot slanted with respect to the worm screw axis and obtained in a bracket integral with the lower back.

7. A device according to claim 5, characterized in that it provides for a connecting rod and lever system kinematically connected to the upper false back and to the lower false back and to the lower false back to transmit the displacement movement from one back to the other.

8. A device according to claim 1, characterized in that it comprises a vertical wall that can translate in order to widen or shorten the discharge channel dimension depending on the vessel dimension.

9. A device according to claim 1, characterized in that it provides a slanted wall upward hinged to the vertical wall which has a varying position depending on the slider of the cradle, said slanted wall being able to be subjected to a rotating-translating movement.

10. A device according to claim 9, characterized in that it comprises a plate integral with the lsanted wall whose function is closing the space that is created in the bottom wall when said slanted wall moves.
